(19) United States
(12) Patent Application Publication
(10) Pub. No.: US 2015/0310228 A1
(43) Pub. Date: Oct. 29, 2015

(54) SECURED MOBILE GENOME BROWSING DEVICES AND METHODS THEREFOR

(71) Applicant: Nantomics, Culver City, CA (US)

(72) Inventors: Stephen Charles Benz, Santa Cruz, CA (US); James Kytola, Wayland, MA (US); John Zachary Sanborn, Santa Cruz, CA (US); Patrick Soon-Shiong, Los Angeles, CA (US)

(21) Appl. No.: 14/632,816

(22) Filed: Feb. 26, 2015

Related U.S. Application Data
(60) Provisional application No. 61/944,946, filed on Feb. 26, 2014.
(60) Provisional application No. 62/022,103, filed on Jul. 8, 2014.
(60) Provisional application No. 62/062,057, filed on Oct. 9, 2014.

(51) Int. Cl. G06F 21/62; G06F 19/00; H04L 29/06; H04L 29/08

(52) U.S. Cl. CPC G06F 21/6263; H04L 67/02; G06F 19/322; H04L 63/04

(57) ABSTRACT

A secured mobile genome browsing device is disclosed. The device can store genome data in a webapp format within an isolated, secured container in memory. The device further comprises a genome browser module that identifies relevant genome data and renders the relevant genome data, including drug interacting information, on a display of the device according to genome browsing constraints.

This application claims the benefit of priority to U.S. provisional applications having Ser. No. 61/944,946, filed on 26-Feb.-2014, Ser. No. 62/022,103, filed on 8-Jul.-2014, and Ser. No. 62/062,057, filed on 9-Oct.-2014.

### FIELD OF THE INVENTION

The field of the invention is storage, access, and use of omic data on mobile devices, especially as it relates to presentation of and interaction with omic data under constraints due to the mobile device.

### BACKGROUND OF THE INVENTION

The background description includes information that may be useful in understanding the present invention. It is not an admission that any of the information provided herein is prior art or relevant to the presently claimed invention, or that any publication specifically or implicitly referenced is prior art.

All publications herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

Analysis of an individual's genomic data holds great promise in personalized medicine. A whole genome sequence of an individual human can comprise over 3,000,000,000 base pairs, which naively could be stored in about 3 GB assuming storing raw genome data and single coverage only. The whole genome can consume even larger amounts of memory if raw sequence reads are stored and if the genome is read to a depth of, for example, 30-50×. As a consequence, large scale computer systems are often employed to analyze genome information. Unfortunately, the sheer size and scale of information available related to a genome prohibits ease of access, especially at a point-of-care where hand-held mobile devices are common. For example, U.S. Pat. No. 7,251,642 to Szeto titled “Analysis Engine and Work Space Manager for Use with Expression Data”, filed Aug. 6, 2002, discusses a run-time engine that allows for analyzing gene expression data through memory mapped file in a work space. Although useful for workstations, such an approach is unsuitable with respect to mobile devices.

Still, some progress has been made toward reducing large data sets for presentation. For example, U.S. patent application publication 2010/0161607 to Singh et al. titled “System and Method for Analyzing Genome Data”, filed Nov. 6, 2009, discusses a genome analysis data server capable of providing reduced or summarized genome data to client devices over a wide area network. In a somewhat similar vein, European patent application publication EP 2 759 963 to Plattner et al. titled “System and Method for Genomic Data Processing with an In-Memory Database System and Real-Time Analysis”, filed Jan. 28, 2013, describes a system that provides cloud application supporting physicians and researchers in identifying genetic roots for certain tumor types. The system further supports browsing genes on mobile devices. However, it is insufficient to merely present genome data, even at a point of care event. Rather, it would still be necessary to maintain security or privacy of the individual while also being responsive to urgent data requests especially in a constrained environment of a smart phone or other embedded device.

At some level, further progress toward interactivity is made by U.S. patent application publication 2010/0286994 to Tebbs et al. titled “Interactive Genome Browser”, that was filed Nov. 6, 2009. Tebbs describes an interactive genome browser that can interactively request genome data from a genomic server, but fails to account for the genome browsing constraints of a mobile device.

Interestingly, although the above art makes progress toward providing genome data, the art fails to appreciate the demands that can exist at a point of care event. For example, the constraints of the event, type of mobile device, and location (e.g., urgency, device constraints, bandwidth, etc.) can impose severe limitations on the responsiveness of the system or amount of data that can be ingested or displayed. Further, the art fails to address a need at a point of care for beneficial drug information as it relates to the individual's genomic information.

Therefore, even though numerous methods, systems, and devices are known in the art to present omics data and to allow user interaction with the same, such devices are generally not suitable for mobile/bedside use. Thus, there remains a significant need for secured, mobile genome browsing devices that allow for omics data presentation and interaction within device constraints imposed by hardware and/or place of use.

### SUMMARY OF THE INVENTION

The inventive subject matter is drawn to various devices, systems, and methods in which a mobile device having limited capabilities can be configured to present genomic information in a secured fashion while presenting data quickly to a user in response to a request or query, especially at a point-of-care event.

One aspect of the inventive subject matter includes a secure genome browsing device comprising at least one processor, a display, a communication interface, and a memory. The memory (e.g., Flash, RAM, SSD, Etc.) is configured to store one or more genome browsing constraints that indicate limitations of the device. Further, the memory is partitioned into one or more secured work spaces that can be isolated from other portions of memory or unauthorized processor threads, and that stores private genome data. The communication interface is configured to establish one or more secure communication tunnels to a remote genome web server over a network (e.g., Internet, LAN, cellular, etc.) where a secured work space represents one endpoint of the secure tunnel. For example, the secure tunnel could comprise a VPN connection, an SSL session, or other type of secured communication channel.

The genome browsing device further comprises a genome browser module, executable on the processor that has responsibilities for rendering genome data on the display while respecting the constraints of the device. The genome browser module is configured to query the remote genome web server, via the secure tunnel, for genome data associated with one or more sequences (e.g., a target individual's genome, sequence, gene, variation, mutation, insertion, deletion, etc.) of a genome. In response, the browser module receives the genome data, including drug interaction information related to the genome sequence. The received genome data is received in an expected browser interface format (e.g., a webapp, HTML5, etc.) that is expected by the genome web server. The genome browser module causes the genome data to be stored in the secured work space. The genome browser module also constructs a genome browser interface definition scaled from the expected browser interface format, possibly converting HTML5 code or the webapp into one or more scripts (e.g., QML, Javascript, etc.). The genome browser interface definition is constructed to respect the browsing limitations of the device, while also presenting native device controls. The genome browser module also identifies relevant genome data from the genome data based on the subject of the query and the drug interaction information. Finally, the genome browser module renders the relevant genome data and associated drug interaction information in a genome browser interface on the display according the genome browser interface definition, thereby respecting security constraints as well as conforming to device constraints.

Various objects, features, aspects, and advantages of the inventive subject matter will become more apparent from the following detailed description of preferred embodiments, along with the accompanying drawing.

### BRIEF DESCRIPTION OF THE DRAWING

FIG. 1 is a schematic overview of an exemplary secure genome browsing device.

FIG. 2 illustrates an exemplary screen shot of a secure genome browsing device displaying drug interaction data.

FIG. 3 illustrates an exemplary screen shot of a summary interface showing genomic information in the genome browser interface.

FIG. 4A illustrates an exemplary screen shot of a whole genome sequence presented on the genome browser interface.

FIG. 4B illustrates an exemplary screen shot of native device controls that can interact with the whole genome sequence information of FIG. 4A.

FIG. 4C illustrates an exemplary screen shot of an alternative set of native device controls that can interact with the whole genome sequence information of FIG. 4A.

FIG. 5A illustrates an exemplary screen shot of the genome browser interface showing a collaboration interface and an analysis drill down interface.

FIG. 5B illustrates an exemplary screen shot showing controls for interacting with the information from FIG. 5A.

### DETAILED DESCRIPTION

The inventors discovered that devices, systems, and methods can be implemented to allow a user at a point of care via a mobile device with limited capabilities to interact with omics information in a secured fashion that optimizes the scaling and delivery of information to the device or display on the basis of known browsing device constraints. Contemplated mobile devices will typically be configured as a mobile or wearable genome browsing device capable of providing visual or auditory feedback and accessing a network, ideally in a secured environment. Contemplated mobile devices may also comprise an omics analysis engine that is coupled with the secured computer readable memory and that is configured to (1) obtain at least one omic object (e.g., genomic data, RNomic data, proteomic data, exomic data) according to a secure protocol, (2) generate at least one recommendation by applying an omic analysis rule set to the at least one omic object, and (3) initiate an action via an interface according to the recommendation.

For example, suitable devices include a cell phone, a tablet or phablet, a smartphone, smart glasses, a smart watch, forearm display device, personal area network devices, instrumented clothing, a gaming device, a medical device or instrument, a laptop, or other type of portable devices. Contemplated mobile devices provide some form of user feedback through one or more user interfaces. Example interfaces on the mobile device can comprise device screens, real-world overlays (e.g., augmented reality, projected reality, etc.), text-to-speech, pre-recorded audio, virtual retinal display, tactile interfaces (e.g., vibrations, Braille, 3D printers, etc.), automatic speech recognition interfaces, touch-sensitive displays, or other types of interfaces. Consequently, the device constraints will be at least in part dictated by one or more features genuine or native to such devices. For example, a typical genome browsing device constraint will be limited RAM space (e.g., equal or less than 4 GB), limited data storage capacity (e.g., equal or less than 64 GB), limited processor capability (e.g., single core processor), limited data transfer speed (e.g., using Bluetooth or WiFi), limited display area and/or resolution, etc. It should be appreciated that the limitations of the genome browsing device will be imposed due to physical size of the device relative to larger computing systems (e.g., desktop, workstations, web servers, etc.).

It should be noted that any language directed to a computer should be read to include any suitable combination of computing devices, including servers, interfaces, systems, databases, agents, peers, engines, controllers, or other types of computing devices operating individually or collectively. One should appreciate the computing devices comprise a processor configured to execute software instructions stored on a tangible, non-transitory computer readable storage medium (e.g., hard drive, solid state drive, RAM, flash, ROM, etc.). The software instructions configure the computing device to provide the roles, responsibilities, or other functionality as discussed below with respect to the disclosed apparatus. Further, the disclosed technologies can be embodied as a computer program product that includes a non-transitory computer readable medium storing the software instructions that causes a processor to execute the disclosed steps associated with implementations of computer-based algorithms, processes, methods, or other instructions. In especially interesting embodiments, the various servers, systems, databases, or interfaces exchange data using standardized protocols or algorithms, possibly based on HTTP, HTTPS, AES, public-private key exchanges, web service APIs, known financial transaction protocols, or other electronic information exchanging methods. Data exchanges among devices can be conducted over a packet-switched network, the Internet, LAN, WAN, VPN, or other type of packet switched network; a circuit switched network; cell switched network; or other type of network.

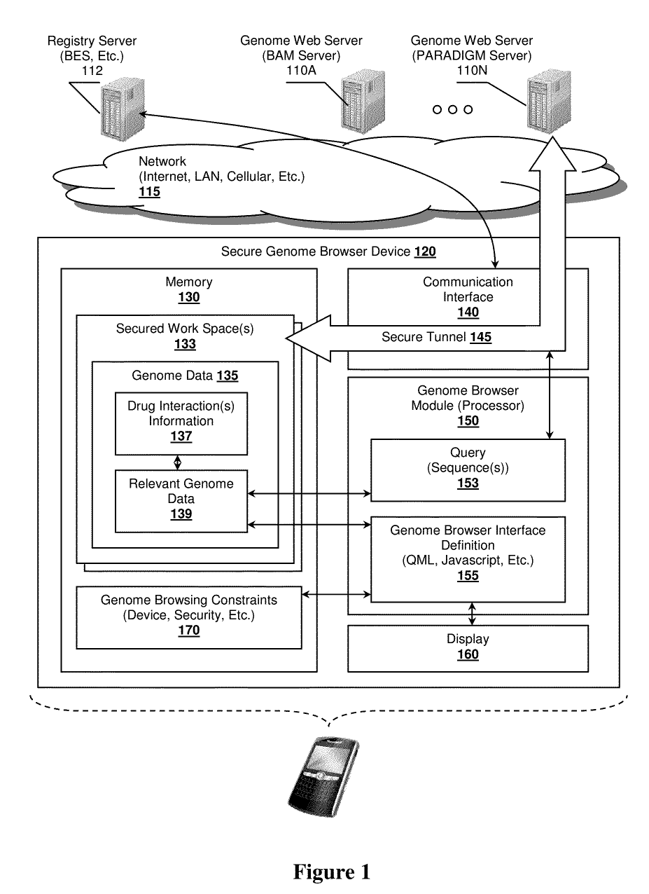

FIG. 1 presents an overview of an exemplary secure genome browsing device 120 that can render genome data for consumption by a stakeholder (e.g., patient, doctor, oncologist, etc.) at a point-of-care. In the example shown, secure genome browsing device 120 includes a smart phone (e.g., BlackBerry®, iPhone®, Android®, etc.) that requests genome data over network 115 from genome web servers 110A through 110N, collectively referred to genome web servers 110. It should be appreciated that the ecosystem presented in FIG. 1 outlines a secured environment through which private genome data and drug interactions can be exchanged, stored, analyzed, rendered, or otherwise managed. For the sake of discussion, the inventive subject matter will be presented from the perspective of a BlackBerry device (e.g., Z30, Z10, Q10, P'9982, PlayBook, etc.) in the hands of an oncologist at a point of care.

In the ecosystem presented, devices and services can be managed through registry server 112. For example, registry server 112 could comprise a BlackBerry Enterprise Server™ (BES), which coordinates communications among registered enterprise-level applications and mobile devices. Secure genome browsing device 120, perhaps a BlackBerry PlayBook, registers with registry server 112 in order to identify itself as a consumer of one or more digital web services. In the illustrated case, the services can include web services provided by genome web servers 110, which have also registered their services at registry server 112. Thus, registry server 112 is able to authenticate the various devices and services in the ecosystem to ensure that each element is authorized to exchange data with other elements or to consume registered services. For example, consider a scenario where clinician begins a shift in an emergency room. As they clinician enters the ER, their device can register with registry server 112 based on contextual location information and seek authorization for accessing genomic data of patients on genome web servers 110. Accessing a patient's genome data via genome web servers 110 allows the clinician to determine which drugs might have beneficial or adverse drug interactions with the patient's genome (e.g., pathway expressions, RNA messaging, etc.).

Genome web servers 110 comprises web servers configured to provide digital genomic data over network 115 via one or more digital protocols (e.g., HTTP, HTTPS, SSL, SSH, FTP, SFTP, TCP/IP, UDP/IP, SMTP, SMS, MMS, etc.). In general, genome web servers 110 are configured to respond to network-based requests by transmitting genome data across network 115 in an expected browser interface format; possibly HTML5, a rendering language, or other webapp formats (e.g., Javascript, CSS, AJAX, etc.). An example server includes a web server that provides genome data based on BAM formats, SAM formats, GAR format, or even BAMBAM formats as indicated by genome web server 110A. BAMBAM servers can be constructed through suitable configuration of the technologies described in U.S. patent application publications 2012/0059670 (filed May 25, 2011) and 2012/0066001 (filed Nov. 18, 2011) both to Sanborn et al. and titled “BAMBAM: Parallel Comparative Analysis of High-Throughput Sequencing Data”. Another example of a genome data analysis technology that can be adapted for use as a genome web server includes those described in international patent application publications WO 2011/139345 (filed Apr. 29, 2011) and WO 2013/062505 (filed Oct. 31, 2011) both to Vaske et al. and titled “Pathway Recognition Algorithm Using Data Integration of Genomic Models (PARADIGM)”, as indicated by genome web server 110N. Yet another example of a genome data management technology that could be adapted to provide genome data services includes those described in U.S. patent application publication 2010/0161607 to Singh et al. titled “System and Method for Analyzing Genome Data”, filed Nov. 6, 2009.

Network 115 comprises a digital communication infrastructure through which the devices of the ecosystem exchange digital data. In some embodiments, network 115 can comprise a wireless network where devices communicate via one or more wireless protocols via complementary communication interface 140: Bluetooth, 802.11, WiMAX, WiGIG, cellular, wireless USB, etc. for example. Consider an example of a hospital environment where a clinician operating a BlackBerry PlayBook device as secure genome browsing device 120 is local to genome web servers 110 deployed within the hospital. The BlackBerry device can communicate with network 115 via 802.11 protocols (e.g., 802.11n, 802.11a, 802.11b, 802.11g, 802.11ac, etc.). In other contexts where the clinician is remote from the hospital beyond the range of local connections, the BlackBerry device can be configured to exchange data over a cellular network (e.g., LTE, GSM, EDGE, etc.). Although less ideal due to physical limitations of wires, network 115 can also include a wired network; Ethernet, USB, etc. for example, in circumstances where mobility is not a requirement.

Secure genome browsing device 120 comprises a computing device having multiple components that cooperate together to fulfill the roles or responsibilities described below. Secure genome browser device 120 includes a processor (e.g., ARM®, Snapdragon®, Adreno®, Marvell, etc.), display 160, memory 130, communication interface 140, and genome browser module 150 executable on the processor according to software instructions stored in memory 130. Example devices that can be suitably configured to operate as the disclosed browser device include mobile phones, smart phones, robotic assistants, tablets, phablets, medical appliances, or other devices. Memory 130 includes support for persistent storage of digital data and can include RAM, FLASH, solid-state drive, SD card, HDD, or other types of storage devices. Although not shown, secure genome browsing device 120 is considered to include an operating system supporting the underlying device infrastructure (e.g., threading, file access, device drivers, etc.). For example, a BlackBerry device can be configured with a QNX® kernel. Other example operating systems include VxWorks®, Linux, Android, or other operating systems configured to operate on mobile devices.

Memory 130 is configured or programmed to store genome browsing constraints 170 and to store private genome data 135 within secured work space 133. Memory 130 is partitioned or otherwise segmented into one or more of secured work space 133 in which genome browser module 150 operates on data as it renders portions of genome data 135 while also ensuring an individual's genome data remains confidential. In some embodiments, memory 130 can comprises multiple secured work spaces 133 where each secured work space 133 is isolated from other secured work spaces 133. For example, an oncologist might request access to private genome data for multiple patients where each patient's genome data 135 is stored separately from others in an assigned secured work space 133. Thus, each patient's data can remain isolated and segregated from other patient's data thereby preventing accidental disclosure through inadvertent actions by the oncologist.

Secured work space 133 can be established through one or more techniques. In some embodiments, the operating system of the device can establish secured work space 133 by allocating a contiguous section of memory and encrypting the data stored in secured work space 133. Alternatively, secured work space 133 is not encrypted, but rather stores genome data 135 according to an encrypted format, perhaps based on a key exchange with genome web servers 110. For example, genome browser module 150 can be provided a patient key or token that allows genome browser module 150 to decrypt secured work space 133 or genome data 135 in order to operate on the data. In other embodiments, secured work space 133 can comprise a partition of memory dedicated to an instantiated virtual machine running on genome browsing device 120. Still further, in view that secure genome browsing device 120 seeks to hold patient data in confidence, secured work space 133 can be configured or programmed to adhere to one or more security standards; FIPS 140-2 for example. Returning the BlackBerry example, a QNX operating system (e.g., QNX kernel) can establish one or more secure partitions for use by multi-core processors. Even further, secure partitions can be instantiated for use based on tools such as VeraCrypt (see URL veracrypt.codeplex.com) or CipherShed (see URL www.ciphershed.org), which are open source utilities for creating on the fly encrypted partitions. In such a case, the execution of genome browser module 150 can be locked down with respect to one or more patient's data. The secure partitions can also be nested to respect various access levels. For example, the secure partition could have a basic level of encryption that is configured to allow access by a technician, an oncologist, and the patient. The partition could include an additional secured container that is encrypted based on a second key or type of algorithm that is configured to restrict access to only the doctor or patient. Even further, the secured container could also include a yet another secured container that is only accessible by the patient. Data stored in each successive container would likely be considered more sensitive.

Alternatively, or additionally, secured work space 133 may also be configured to operate as an omic data store that stores omic objects (e.g., proteomic data, whole genome sequence data, RNomic data, exome expression, etc.) representative of at least a portion of an omic data set, wherein the omic objects may be actual sequences or portions thereof, or difference objects between tumor and normal nucleic acid sequences, or difference objects between a reference nucleic acid and tumor and/or normal nucleic acids, etc. In further contemplated devices, an omic analysis engine (not shown) is coupled the with the secured computer readable memory and configured to (a) obtain at least one omic object (e.g., representative of whole genome sequence information, exome sequence information, transcriptome sequence information, and/or proteome information) according to a secure protocol, (b) generate a recommendation by applying an omic analysis rule set to the at least one omic object; and (c) initiate an action via an interface (typically via the genome browser interface) according to the recommendation.

Memory 130 is also configured or programmed to store genome browsing constraints 170. Genome browsing constrains 170 include data elements indicating the limitations associated with secure genome browsing device 120. In view that secure genome browsing device 120 has limited features relative to full desktop computers, workstations, or servers, the ability of secure genome browsing device 120 to browse genome data can also be quite limited. Genome browser constraints 170 can include a broad spectrum of constraints that can impact the browsing experience. It should be noted that genome web servers 110 do not necessarily require access to genome browsing constraints 170. Rather, in more interesting embodiments secure genome browsing device 120 can leverage genome browsing constraints 170 to generate an acceptable experience of the stakeholder while browsing genome data 135 in a manner that can be considered as transparent to web servers 110. This approach is considered advantageous because it allows for each secure genome browsing device 120 to handle their own constraints individually without requiring modification to genome web servers 110 or the webapp information web servers 110 provide to ordinary browsers. This approach is especially important as new devices (e.g., new phones, smart watches, etc.) in the field become more prevalent.

Genome browsing constraints 170 can include browsing device constraints that reflect the physical constrains of the device. One example of a physical constraint can include a memory constraint indicating the limitations of memory capacity available for genome data 135, possibly the size of a secure partition. The memory constraint can comprise a total capacity of the physical memory, a virtual capacity, a current allocated capacity, an access latency, a security level (e.g., FIPS 140-2 levels 1 through 4, etc.), capacity of a secured partition or container, maximum allocable capacity, or other memory constraint. Another example of a device constraint includes a computational constraint. Computational constraint might include a number of cores in the processor, an amount of processing power available for use (e.g., MIPS, a percentage, time slice, latency budget, etc.), presence or lack of cryptographic support (e.g., hardware support, software support, etc.), computational costs (e.g., power consumed, etc.), GPU or graphical rendering bandwidth, number of available threads, or other computational constraint. Still another type of device constraint could include a network constraint that could impact the experience of the stakeholder in accessing genome data 135. Perhaps the network bandwidth available might restrict the amount of genome data 135 that can be accessed or could impact the latency on browsing requests. Example network constraints can include latency, data plan costs, bandwidth, ping times, protocol support, or other network-related constraints. Still further, device constraints can also include display constraints that indicate specific issues that might relate to display 160. For example, the display constraints might include size of the display, aspect ratio, refresh rate, input limitations (e.g., touch sensitivity, etc.), pixel density, dimensional support (e.g., 2D, 3D, etc.), supported rendering formats (e.g., video codecs, audio codecs, etc.) or other type of display constraint. Genome browsing constraints for a genome browsing device can be identified in numerous manners, including automated manners (e.g., using software that identifies operational capabilities and/or presence of components), or be based on a priori knowledge of the configuration and capabilities of the genome browsing device.

Beyond device-related constraints, genome browsing constraints 170 can include non-device related constraints, possibly including security constraints. The security constraints could have some overlap with computational constraints, possibly including an indication of cryptographic support. For example, the security constraints could include an indication of presence of a cryptographic chip (e.g., Freescale® C29x), or presence of cryptographic support routines in the operating system. Thus the security constraints might indicate that there is local support for public key algorithms (e.g., RSA, Diffie-Hellman, ECC, etc.), AES, 3DES, HMAC, SHA, FIPS 140-2, or other features. The security constraints could also include an access level constraint, a privacy constraint, a security strength constraint, or even an anonymity constraint. Additional non-device related constraints can include user constraints, possibly reflecting an aspect of a stakeholder or a collaborator: a patient, a caretaker, a pharmacist, a researcher, an insurance provider, a technician, a doctor, a nurse, or another individual involved with the target individual. Additional genome browsing constraints 170 could include a context, a location, a time, a geo-fence boundary, a user preference, or other type of constraint.

Genome data 135 includes digital data representing one or more aspects of an individual's genome. Genome data 135 could comprise a wide variety of genomic information or related information. In some scenarios, genome data 135 could comprise a whole genome sequence of the individual. In such cases the entire sequence might consume nearly 3 GB of data, assuming an uncompressed raw data file. Depending on the data format used to store genome data 135, the amount of memory 130 that is consumed by genome data 135 could vary substantially. For example, BAM file format having a depth of 50× reads, might require about 150 GBs (i.e., 3 GB×50). The reader is reminded that secured genome browsing device 120 has numerous constraints, including memory constraints, relative to desktop or workstation devices having access to large capacity hard drives. The reader is further reminded that secure genome browsing device 120 is configured or programmed to browse multiple, isolated genome data sets for multiple patients at the same time. Therefore, genome data 135 can be stored in a compressed format. Although a compressed format conserves space, it requires computational resources to un-compress the data in order to access the data, which can impact the user experience due to the latency incurred during decompression. Alternatively, genome data 135 might be a subset of the individual's genome. For example, genome data 135 comprising a subset of a whole genome might include one or more of differences relative to a reference genome, a substitution, a deletion, an insertion, a gene, a cancer gene, a missense, an alteration, a mutation, a deviation, a sequence location, an allele fraction, one or more SNPs, one or more STRs, a chromosome, or other information related to the subset of the whole genome. Further exemplary genome data may include RNA sequencing information (mRNA and miRNA), protein levels (both quantitative and predicted), CHIP-Seq, Methylation information (bisulfide or other methods), and information regarding spatial configurations of chromosomes or proteins.

In still further contemplated aspects, the genome data for use herein may be based on or reconstructed from a reference genome model. In such system, patient specific deviations from the reference genome model may be expressed as difference objects (e.g., in BAMBAM format) or constellation of difference objects. Such model system would advantageously allow simple graphical illustration of genomic changes/variations in symbolic form on a higher zoom level, while zoom-in may render graphical representations of sequence elements into actual sequence information. While not limiting the inventive subject matter, such zoom function may be based on positional information from a SAM or BAM file, and actual sequence information may be provided to the genome browser by the browser requesting actual sequence data for the position from a sequence database.

Communication interface 140 is configured or programmed to provide digital communication connectivity between secure genome browsing device 120 and network 115 where communication interface 140 includes a complementary physical interface that operates according to protocols supported by network 115. Thus communication interface 140 can include one or more wired interfaces (e.g., Ethernet, USB, Firewire®, etc.) or wireless interfaces (e.g., a Bluetooth interface, an 802.11 interface, a cellular interface, a wireless USB interface, a WiGIG interface, a WiMAX interface, etc.). Communication interface 140 further includes a communication stack (e.g., TCP/IP stack, USB stack, etc.) configured to establish secure tunnel 145 over network 115 with at least one of genome web servers 110. Secure tunnel 145 can take on different natures depending on the desired structure of the communication channel between secure genome browsing device 120 and genome web servers 110. Consider a scenario where an oncologist leverages a BlackBerry PlayBook as secure genome browsing device 120 within a clinic that locally hosts genome web servers 110 on a private LAN. In such a scenario, communication interface 140 can establish a secured protocol connection as secure tunnel 145. For example, secure tunnel 145 could comprise a communication channel built on SSL, HTTPS, or even an SSH secured protocol. In scenarios where the oncologist, or other user, is located remotely relative to the private network where genome web servers 110 are hosted, secure tunnel 145 can comprises a VPN connection so that communication interface 140 appears substantially as a secured local device from the perspective of genome web servers 110. Still further, in scenarios where genome web servers 110 operate as a cloud-based service (e.g., PaaS, IaaS, SaaS, etc.), secure tunnel 145 could couple with web services offered by genome web servers 110 possibly over an HTTPS connection. Yet another example of secure tunnel 145 could include a channel constructed through an anonymity protocol (e.g., TOR, etc.) which can further secure privacy of individuals accessing genome data 135, while also respecting authorization.

The example shown in FIG. 1 illustrates communication interface 140 as establishing one secure tunnel 145 where secured work space 133 represents an end point for secure tunnel 145. For example, the end point of secure tunnel 145 can comprise an instantiation of a virtual machine (e.g., VMWare®, Xen, etc.) that uses secured work space 133 as its local memory. As data is exchanged via secure tunnel 145 with genome web servers 110, the virtual machine can store genome data 135 in secured work space 133, use secured work space 133 for communication buffers, or otherwise manage secured work space 133 during browsing. It should be further appreciated that more than one secure tunnel 145 could be established; perhaps one for each secured work space 133 dedicated to one of multiple individuals or patients. This approach is considered advantageous because it allows secure genome browsing device 120 to isolate each individual's genomic information from others that might be present on the device. More specifically, each secure tunnel 145 not only can store their respective genome data 135 in different, isolated secured work spaces 133, but can also use distinct or different sets of communication buffers so that there is no risk of genomic data “leaking” or buffer overflows from one communication channel to another via shared buffers. One should appreciate that each virtual machine could even host their own communication stack that is independent of and isolated from other virtual machines, especially where each virtual machine is dedicated to a specific patient.

Additionally, or alternatively, genomic data can be streamed directly from a local or remote datacenter for active analysis or storage purposes. Techniques that can be leveraged for streaming or storage are discussed in WO/2013/086355 “Distributed System Providing Dynamic Indexing and Visualization of Genomic Data”. Genome exchange could happen securely between devices after authentication, without need for intermediary servers (peer-to-peer exchange). Other suitable techniques of transporting genome information may be discussed in U.S. Ser. No. 14/541,068 “Systems And Methods For Transmission And Pre-Processing Of Sequence Data”.

Secure genome browsing device 120 further comprises genome browser module 150 configured or programmed to execute on the processor, processors, or cores of secure genome browsing device 120. In some embodiments, the software instructions associated with genome browser module 150 could be stored in secured work space 133 to provide further isolation or security with respect to browsing genome data 135. One example of a genome browser that can be suitably adapted to incorporate the features described herein includes the UCSC genome browser (see URL genome.ucsc.edu/index.html). Additional technologies that can contribute to genome browser module 150 include those offered by Five3 Genomics (see URL five3genomics.com) or Nantomics (see URL nantomics.com).

Genome browser module 150 has numerous roles or responsibilities related to allowing a user of secure genome browsing device 120 to access or browse genome data 135 in a secure and confidential manner within the constraints of the device. Genome browser module 150 is configured or programmed to submit query 153 via secure tunnel 145 to one or more of genome web servers 110 for genome data 135 associated with one or more of a target genome sequence. Query 153 includes information related to an aspect of a target genome. At a basic level, query 153 might only include an individual patient identifier (e.g., patient name, SSN, etc.) indicating that a whole genome sequence is desired. However, query 153 can comprises more complex information that relates to the target genome. In some embodiments, query 153 could comprise a serialized data structure (e.g., XML, JSON, YAML, etc.) that encapsulates a request for genome data along with request attributes. For example, the request can include a patient identifier, a user identifier, genome browsing constraints 170, a gene name, a sequence location, a sequence length, a specific sequence string, a protein, a DNA sequence, an RNA sequence, pathway information, drug information, or other properties that can be consumed by one or more of genome web servers 110 in order to generate a results set. Query 153 can be generated based on a user input (e.g., via spoken utterance, via touch screen, etc.), face recognition of a patient, or through automatic generation based on context data (e.g., location, time, ambient collected data, personas, etc.).

Genome browser module 150 is further configured or programmed to receive genome data 135 via secure tunnel 145. Genome data 135 is received in an expected browser interface format (e.g., prepared webapp, etc.) of the responding genome web server 110. To be clear, web server 110 responds under the assumption that the receiving device is fully capable of ingesting genome data 135. For example, if query 153 targets genome web server 110A, genome data 135 might comprise genome sequence information in a BAM format, possibly encapsulated within a webapp language. Genome data 135 can be stored in the same format or could be striped of formatting in preparation for rendering locally on display 160. It should be appreciated that genome web servers 110 are not necessarily required to adjust the formatting of genome data 135. Rather, genome browser module 150 on the browsing device can be configured to accommodate multiple webapp formats from genome web servers 110, which can then be converted and integrated together for presentation. Thus, genome data 135 can adhere to the presentation formats provided by genome web servers 110. Example presentation formats include HTML5, Javascript, QML, AJAX, Flash, Silverlight, scripting languages, or other formats that could be executed within the browser environment. Still, the presentation format provided by genome web servers 110 does not necessarily represent the rendering format used by the genome browser module 150.

In more interesting embodiments, genome data 135 also includes one or more portions of drug interaction information 137 related to the query sequence. For example, the drug interaction information 137 can include a listing of drugs that have interactions with druggable genes of genome data 135, or more specifically alterations in druggable genes. Drug interaction information 137 can include a vast amount of information related to drugs. Example drug information can include a plurality of drugs, a type of interaction, a name, a cost, a source, a distributor, other interactions unrelated to the query sequence, known drug studies, current drug studies, drug response studies, related longitudinal studies, or other drug information.

In view of the constrained capabilities of secure genome browsing device 120, genome browser module 150 is unable to present genome data 135 fully in the webapp formats expected by genome web servers 110. Therefore, genome browser module 150 is yet further configured or programmed to construct or otherwise instantiate a genome browser interface definition 155 scaled from the expected browser interface format according to one or more of genome browsing constraints 170. For example, genome data 135 might comprises a BAM format presented according to a CSS definition and that includes numerous reads that might not be able to be presented on display 160. In response, genome browser module 150 can scale down the presentation to a set of QML commands for presentation via a Qt framework on display 160 where the QML commands convert or scale the presentation information to adhere to the display constraints in genome browsing constraints 170. Genome browser interface definition 155 can also include rules relating to filtering genome data 135 according to security constraints, to prioritizing further queries 153, to activating or deactivating browsing commands, or other activities. Thus, genome browser module 150 can be considered as scaling presentation of genome data 135 from the webapp formats of genome web servers 110 to a target genome browser interface definition 155 within native device controls. Genome browser interface definition 155 could instantiated in real-time, possibly using an interface script file (e.g., Lua, Python, Perl, Ruby, etc.), QML, Javascript, or other interface definition language. It should be appreciated that genome browser interface definition 155 could comprise a de novo interface constructed or instantiate in real-time, possibly where none existed before reception of genome data 135 and where browser interface definition 155 is generated based on a set of rules or procedures that operate under criteria defined based on security or physical constraints of the device.

Genome browser module 150 is also configured to or programmed to identify or recognize relevant genome data 139 from genome data 135 as a function of the genome sequence associated with query 153 and drug interaction information 137. Relevant genome data 139 represents the target information that is capable of being displayed according to genome browser interface definition 155 while being limited by genome browsing constrains 170 and while attempting to satisfy query 153. Relevant genome data 139 can also take on many different forms while being considered a filtered set of data or a scaled set of data that focuses on the apparent needs of the user. Examples of relevant genome data 139 that relate to genomic information per se includes a substitution, a deletion, an insertion, a gene, a cancer gene, a missense, an alteration, a mutation, a deviation, a sequence location, an allele fraction, SNP data, STR data, a whole genome, a chromosome, a visual representation of at least a portion of the genome, or other data that directly relate to the genome of interest. Additionally, relevant genome data 139 can include additional information or metadata about the nature of the genomic data. For example, relevant genome data 139 can comprise tissue sample information (e.g., a normal tissue sample, a tumor tissue sample, a reference tissue sample, etc.), somatic mutations associated with drug interaction information 137, a deviation in copy number associated with drug interaction information 137, druggable gene (e.g., gene, sequence, an alteration, etc.) associated with the drug interaction information 137, or other related metadata. Still further, relevant genome data 139 can also include information associated with studies or active research associated with genome data 135. For example, relevant genome data 139 can include links to research associated with genes or mutations, to studies currently underway, to studies accepting candidates or participants, to drug trials, or other types of research. Such information is considered advantageous when an oncologist might encounter a life-or-death situation where their patient could benefit of cutting edge research or studies. Further, the patient might be a candidate for such studies.

It should further be appreciated that the relevant genome data 139 and/or genome data 135 may be stored in one or more of a variety of formats, from the level of variant calls (differences from a reference genome or genomes) in a format like VCF (Variant Call Format) or MAF (Mutation Annotation Format). It should also be appreciated that the genomic data can be distributed across multiple local or remote devices as well as at least partially stored local to the mobile device, possibly according to a file system. These files could be augmented with a local copy of the reference genome allowing reconstruction of the entire genome on demand. In such embodiments, the local copy could be complete, assuming sufficient memory, or could represent a fractal representation of the data to reduce memory requirements. Thus, the data store can store at least a portion of a complete genomic data set. Depending on the network bandwidth of the device, regions of interest or entire genomes can be stored at the read level for additional fidelity. These regions can be stored in a SAM or BAM file format, and additionally compressed using a reference-based compression scheme or using a lossy compression scheme by binning read quality scores or pre-filtering using quality metrics. The data could be encrypted using techniques such as public/private key encryption or homomorphic encryption.

Genome browser module 150 is further configured or programmed to render relevant genome data 139 and associated drug interaction information 137 in a genome browser interface on display 160 according to genome browser interface definition 155. For example, relevant genome data 139 could include information related to one or more cancer genes (e.g., TRIO, CASP8, BMPR2, etc.) that also includes chromosome locations. The information can be summarized and presented on display 160 based on an interface rendered based on QML script generated to accommodate rendering relevant genome data 139 and respecting genome browsing constraints 170. Further, the display can be partitioned into frames, windows, or other partitions to provide for presenting browser interfaces for multiple patients. The rendered relevant genome data can include reduced or analyzed data possibly based on a mutation analysis or cytogenetic analysis. The rendered data can also include one or more graphical representations of a genomic analysis of at least a portion of the genome.

One should appreciate that the genome information rendered on display 160 can also include recommended genome data collaborators. This approach allows the oncologist or clinician to interact or share relevant genome data 139, subject to authorization or authentication, with others having similar secure genome browser devices 120. In such a case, a collaborator's device can be synchronized with genome browser device 120 so that both stakeholders can view the data at the same time in the same state. As one collaborator operates on the relevant genome data 139, the other collaborator(s) would observe the effect on their own display. The devices can be synchronized via registry server 112, or where one of the devices (e.g., the sharing device, etc.) operates as a master while the other operates as a client. Such communications can be conducted in a peer-to-peer fashion if desired. Depending on the nature of the collaborators, the same information can be rendered differently based on user constraints. For example, an oncologist might see relevant genome data 139 presented from an oncologist's perspective (e.g., identification of cancer genes, drugs, etc.) while a geneticist might see relevant genome data 139 in more detail (e.g., sequences, genes, variants, etc.) where relevant genome data 139 is rendered according to each user's technical profile.

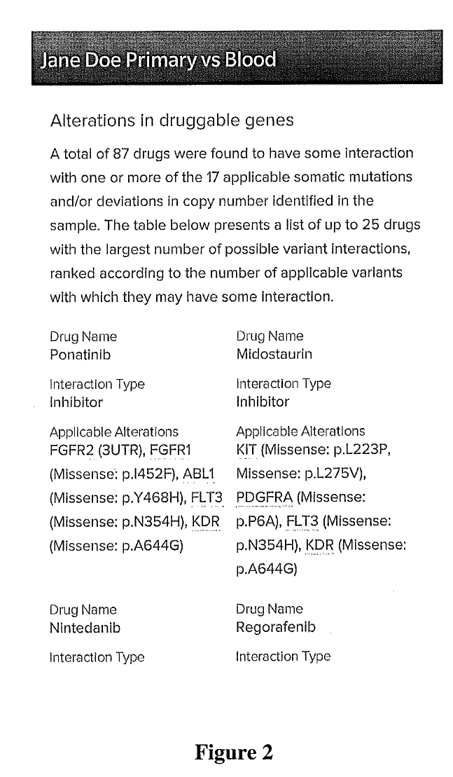

FIG. 2 presents a screen shot of a genome browser interface on a BlackBerry device that illustrates a distillation of relevant genome data as well as drug interaction information. In the example shown, the genome browser identifies deviations in an individual's genome. In addition, the genome browser obtains drug interaction information that includes drugs (i.e., 87 drugs) that have interactions with one or more somatic mutations or deviations in copy number in a tissue sample. The genome browser further presents a table that lists the drugs with their associated information. For example, the table includes a drug name, interaction type, applicable alterations, or other data. It should be appreciated that this interface is generated using QML in a Qt framework based on the genome data provided by one or more genome web servers according to their own webapp formats. This interface has been scaled down from the interface that would ordinarily be generated based on the webapp presentation format provided by the genome web servers. It should especially be appreciated that this approach does not require modification of the existing applications running on the genome web servers or webapp definitions, while achieving a native device experience for the user.

The following figures provide additional screen shots obtained from a BlackBerry device and illustrate additional genome browser interfaces. These figures demonstrate converting webapp formats served by genome web servers to native controls and menus for the target BlackBerry device via a Javascript interface.

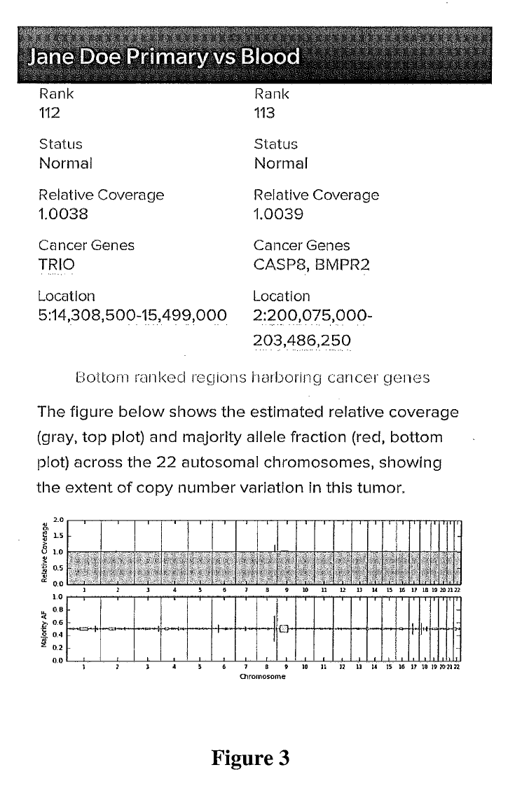

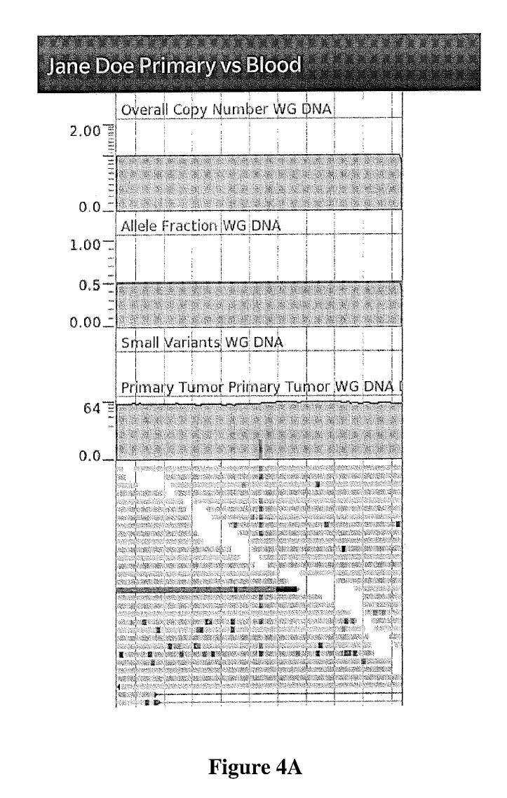

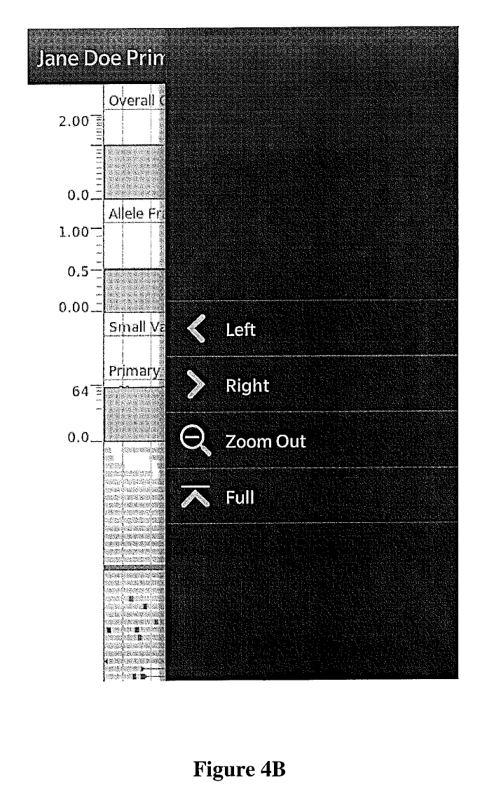

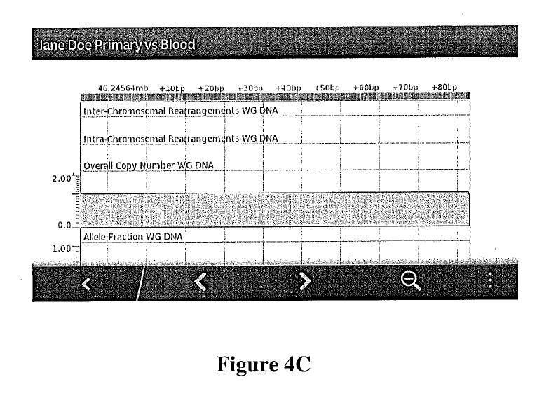

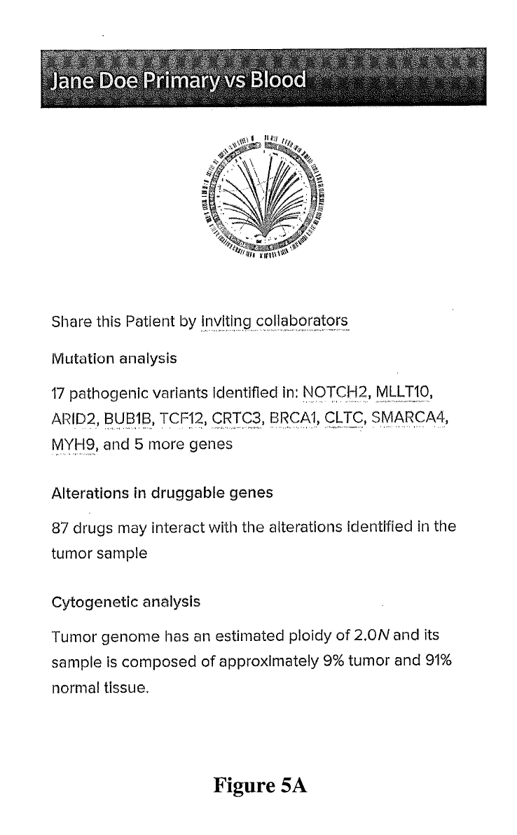

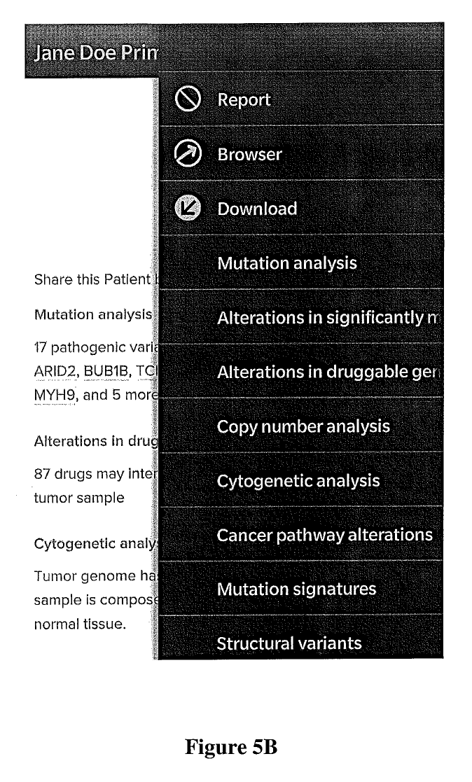

FIG. 3 illustrates presentation of genome data related to cancers genes as well as showing relative coverage across the 22 autosomal chromosomes. FIG. 4A presents a screen shot showing an overview of a whole genome. FIG. 4B illustrates an example set of native controls for interacting with the information from FIG. 4A. FIG. 4C illustrates an alternative example of set of native controls for interacting with the information from FIG. 4A. FIG. 5A illustrates a screen shot showing analysis reports and sharing capabilities. FIG. 5B illustrates an example of set of native controls for interacting with the information from FIG. 5A.

The disclosed approach gives rise to interesting genome browsing capabilities. The genome browser module is able to interact with the locally stored genome data in real-time as the users makes browser request (e.g., zoom in, zoom out, scroll forward, scroll back, time shift, etc.) rather than requiring the browser to make additional requests from the genome web servers. Thus, the mobile secure genome browser can be quite interactive, and in a very real sense, could operate as its own proxy to the genome web servers.

In addition, it should be noted that applications of the genome browsing device can include supporting medication guidance (pharmacogenomics) of recommended doses, appropriate therapies, adverse effects, toxicity, or other medication related activities. Another example includes sample provenance testing to determine if multiple genomes are from the same individual, or testing to determine relationship of individuals (paternity/maternity testing). Yet another example application includes disease testing to determine changes in diseased cells or tissues (cancer), or current white blood cell configuration. The genomic data could be used real-time for treatment and prognostic information or vaccine development. Still further, foreign sequence detection of pathogens can be done to track infection in real-time. Newly acquired genomic information from blood tests can be used to detect circulating tumor cells, or use RNA/DNA information from red & white blood cells to establish health of individuals. This genomic information can be resident partially or wholly on the mobile devices. Thus, contemplated devices and systems can support early notification of disease based on patterns centrally learned and models distributed to device.

One exemplary use is envisioned with the Eviti® (Eviti, Inc., 1800 JFK Boulevard, Philadelphia, Pa. 19103) ecosystem provides an evidence-based cancer care information system from diagnosis through survivorship. In such a setting, the disclosed mobile devices allow healthcare providers access to genomic evidence, in real-time, at each stage of patient interaction. The mobile devices can tie in genomic information with evidence-based standards. Further, the genomic information on the mobile devices can be correlated with efficacy of drugs, clinical trials, and on to final protocols. Thus, real-time genomic correlations can be captured across vast patient populations during actual treatment or simulated trials. Such snap shots can be the foundation or triggers for alerts or other notifications. The notifications can then be routed proper stakeholders based on the correlated genomic information. In a real sense, the mobile devices are a conduit through which genomic information flows to augment evidence-based treatment.

Another ecosystem that can leverage the disclosed mobile devices includes one based on OncoPlexDx® (OncoPlex Diagnostics, 9620 Medical Center Drive, Rockville, Md. 20850) assays and tests. In such an ecosystem, information from each stage of analysis can be injected in the omic data sets across mobile devices worldwide so that healthcare providers or other stakeholders can track tissue analysis no matter their location on the planet. For example, during tissue preparation (e.g., Formalin-Fixed, Paraffin-Embedded (FFPE), etc.), resulting genomic information can be bound with sample or patient information in a manner that allows remote mobile devices to determine origin of the data throughout the full analysis or review. It should be appreciated that each stakeholder, from patients to researchers, have fine grained access via their mobile devices anywhere in the world to the analysis spectrum including cell procurement, specimen preparation sample analysis (e.g., SRM quantitation, MRM quantitation, etc.), genomic profiling, or data analysis. As alluded to earlier, the genomic data can be tagged (e.g., metadata, etc.) with stage information, which gives rise to a real-time analysis stream, possibly as a separate data construct, that couples with the genomic data.

Of particular interest, the disclosed mobile devices can operate as intelligent agents in a clinical operating system (cOS™), possibly based on the NantHealth® (NantHealth, 9920 Jefferson Blvd, Culver City, Calif. 90232) intelligent clinical operating system offering. Mobile devices capable of accessing or storing portions of a genomic data set can operate as an input device or an output device within the cOS ecosystem. For example, the mobile device can acquire one or more “omic” objects and then submit them back to the cOS for storage, processing, or routing to other stakeholder entities throughout the world. In such an embodiment, the mobile device can couple with a sequencing device to acquire the genomic data for the cOS. Alternatively, the mobile device can comprise a sequencing device, or other type of “omic” sensor, configured to acquire the genomic data directly. In addition to acquiring or inputting genomic data, the mobile device can operate as an output device for the cOS by accessing desired genomic data from the cOS infrastructure. The mobile device can be configured to present the genomic data via one or more techniques including operating as a display for the cOS, a report generator, an audio output, or other type of output.

Mobile devices within a cOS can interact with other devices in the cOS ecosystem based on one or more techniques. In some embodiments, each of the devices in the cOS can have its own address so that all the devices can communicate with each other over a network. Example addresses include URLs, URIs, IP address (e.g., IPv4, IPv6, etc.), MAC addresses, or other types of address. In other embodiments, the agents or modules within the mobile devices can have their own network addresses so they can be individually addressed. For example, a clinician's mobile device, perhaps a tablet, can include a genomic browser module within the cOS ecosystem so that the browser for a specific patient has its own IPv6 address even if the mobile device has a different address. In such an embodiment, the mobile device can operate as a cancer genome browser stemming from the cloud (e.g., IaaS, PaaS, SaaS, etc.) that can be genomic data on the screen of the device from a whole genome down to a single base pair

In some embodiments, the mobile devices or even the genomic data itself can be addressed within the cOS based on the content of the genomic data. Thus, the cOS is able to distribute or access the genomic data no matter of the device location or changes in a corresponding mobile device's IP address. One possible approach for assigning addresses include using the genomic sequencing information or metadata (e.g., patient ID, public key, etc.) as an input to create a hash value. The hash value can be considered an address within the hash space. When the cOS wishes to access the corresponding data, the cOS can request the data from connected mobile devices having data with hash values closest to the target hash address. If the connected device lacks the data, it can then forward the request to other connected devices until the data is found. This approach represents a best effort request for data in a peer-to-peer environment where mobile devices might have unreliable connectivity. In other embodiments, the mobile devices or other devices in the cOS can operate on the Apache Hadoop large scale data processing and data storage architecture where the mobile devices could be nodes within the Hadoop distributed file system.

A cOS has numerous types of infrastructural devices in addition to the disclosed mobile devices. Contemplated cOSs can also have agents or modules that operate on networking devices (e.g., switches, routers, gateways, etc.), high performance computing devices, or other devices. Each of the devices in the cOS can have addresses within the same address space as the disclosed mobile devices so that all devices, modules, or other types of agents are able to seamlessly exchange data. For example, an Infinera ATN™ transport network device can include a data plane capable of operating with the cOS, even under direction from a mobile device. Consider a scenario where an analyst's mobile device requires access to a large amount of genomic data, perhaps more than a terabyte of data. The mobile device can configure the layer one transport layer (e.g., data plane of the Infinera ATN) to provision a high bandwidth connection to the data store, perhaps a set of switches storing the target genomic data set or HPC facilities on the National Lambda Rail. The mobile device can then access and present the target genomic data set no matter the device's location and with low latency.

One should also appreciate the disclosed mobile devices also serve as a foundation for cancer prevention measures. As patient tissue data is collected throughout the patient's lifetime, or a part of a treatment, the tissue's genomic information can be integrated along with other aspects of the corresponding patient's genomic data set. In such embodiments, early cell dysplasias can be captured longitudinally from many tissue samples over time, perhaps from lung sputum or secretions. Such genomic information can be compiled across demographics or over the course of generations. All such genomic information can be rendered on the disclosed mobile devices, which further gives rise to identifying extreme outliers or low probability correlations that might be leading indicators or indicate cancer risk long before such cancer occurs.

The amount of data that might be necessary to transfer to the genome browsing device could be quite large. In some embodiments, the genome browser module can use contextual information (e.g., location, time, etc.) to trigger pre-caching genome data. For example, when an oncologist enters their clinic to start a day of work, their mobile device can be provisioned with genome data for all the patients they will see that day. The trigger for provisioning the data can be based on device location to the clinic and the oncologist's appointment schedule. Although the data might be resident on the oncologist's device, it might remain locked until additional contextual criteria are satisfied. To continue the example, a specific patient's genome data might be unlocked when the oncologist's device is proximal to the patient's mobile phone, when the oncologist captures an image of the patient, or during a specific time period associated with the patient's visit.

It should be apparent to those skilled in the art that many more modifications besides those already described are possible without departing from the inventive concepts herein. The inventive subject matter, therefore, is not to be restricted except in the scope of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc. Moreover, all methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention. Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

What is claimed is:

1. A mobile secure genome browsing device, comprising:
a processor;
a display;
a memory storing genome browsing constraints and comprising a first secured work space configured to store private genomic data;
communication interface configured to establish at least one secure tunnel over a network with a genome web server as a function of the genome browsing constraints, the first secured work space representing an endpoint for the at least one secure tunnel; and
a genome browser module, executable on the processor, coupled with the first secured workspace and configured to:
submit a query via to the secure tunnel to the genome web server for genome data associated with at least one genome sequence;
receive via the secure tunnel the genome data, including drug interaction information related to the at least one genome sequence, in response to the query where the genome data is received in an expected browser interface format of the genome web server;
store the genome data in the first secured work space;
construct a genome browser interface definition scaled from the expected browser interface format and according to the genome browsing constraints;
identify relevant genome data from the genome data as a function of the at least one genome sequence and the drug interaction information; and
render the relevant genome data and associated drug interaction information in a genome browser interface on the display according to the genome browser interface definition.

2. The device of claim 1, wherein the least one secured work space comprises an encrypted memory.

3. The device of claim 1, wherein the least one secured work space is a virtual machine memory.

4. The device of claim 1, wherein the at least one secured work space is configured to adhere to FIPS 140.

5. The device of claim 1, wherein the memory comprises a second secured work space.

6. The device of claim 5, wherein the first work space is isolated from the second work space.

7. The device of claim 1, wherein the secure tunnel comprises an anonymous protocol.

8. The device of claim 1, wherein the secured tunnel comprises a VPN.

9. The device of claim 1, wherein the secured tunnel comprises a secured protocol.

10. The device of claim 1, wherein the secured tunnel couples with a web service provided by the genome web server.

11. The device of claim 1, wherein the genome data adheres to a presentation format provided by the genome web server.

12. The device of claim 11, wherein the presentation format is defined according to at least one of the following: HMTL5, Javascript, QML, AJAX, Flash, Silverlight, and a scripting language.

13. The device of claim 1, wherein the rendered relevant genome data comprises at least one of the following: a mutation analysis and a cytogenetic analysis.

14. The device of claim 1, wherein the rendered relevant genome data comprises a graphical representation of a genomic analysis of at least a portion of a genome.

15. The device of claim 1, wherein the relevant genome data comprises at least one of the following: a substitution, a deletion, an insertion, a gene, a cancer gene, a missense, an alteration, a mutation, a deviation, a sequence location, an allele fraction, SNP data, STR data, a whole genome, a chromosome, and a visual representation of at least a portion of the genome.

16. The device of claim 1, wherein the relevant genome data comprises tissue data associated with at least one of the following: a normal tissue sample, a tumor tissue sample, and a reference tissue.

17. The device of claim 1, wherein the relevant genome data comprises a somatic mutation associated with the drug interaction information.

18. The device of claim 1, wherein the relevant genome data comprises a deviation in copy number associated with the drug interaction information.

19. The device of claim 1, wherein the relevant genome data comprises a druggable gene associated with the drug interaction information.

20. The device of claim 19, wherein the relevant genome data comprises an alteration in the druggable gene.

21. The device of claim 1, wherein the drug interaction information represents a plurality of drugs that have known drug interactions with sequences within the relevant genomic data.

22. The device of claim 1, wherein the drug interaction information includes at least one of the following items of information: a type of interaction, a name, a cost, a source, and a distributor.

23. The device of claim 1, wherein the relevant genome data comprises recommended genome data collaborators.

24. The device of claim 23, wherein the relevant genome data comprises synchronized genome data presented on a second, different genome browsing device of at least one of the data collaborators.

25. The device of claim 24, wherein synchronized genome data rendered in the genome browser interface is rendered according to a different format than rendered on the second, different genome browsing device based on a user constraint in the genome browser constraints.

26. The device of claim 25, wherein the user constraint reflects at least one of the following types of data collaborators: a patient, a caretaker, a pharmacist, a researcher, an insurance provider, a technician, a doctor, and a nurse.

27. The device of claim 1, wherein the communication interface comprises a wireless interface.

28. The device of claim 27, wherein the wireless interface includes at least one of the following: a Bluetooth interface, an 802.11 interface, a cellular interface, a wireless USB interface, a WiGIG interface, and a WiMAX interface.

29. The device of claim 1, wherein the genome browser interface definition comprises an interface script file.

30. The device of claim 29, wherein the interface script file is defined according to at least one of the following: Javascript and QML.

31. The device of claim 1, wherein the genome web server comprises at least one of the following: a BAMBAM server and a PARADIGM server.

32. The device of claim 1, wherein the genome browser constraints comprises browsing device constraints.

33. The device of claim 32, wherein the browsing device constraints include at least one of the following: a memory constraint, a computational constraint, a network constraint, and a display constraint.

34. The device of claim 1, wherein the genome browser constraints comprises security constraints.

35. The device of claim 34, wherein the security constraints comprises at least one of the following: an access level constraint, a privacy constraint, a security strength constraint, and an anonymity constraint.

36. The device of claim 1, further comprising an omic analysis engine coupled with the memory and configured to: obtain genomic data according to a secure protocol, generate a recommendation by applying an omic analysis rule set to the genomic data, and initiate an action via the genome browser interface according to the recommendation.

37. The device of claim 36 wherein the genomic data comprise whole genome sequence information, exome sequence information, transcriptome sequence information, and proteome information.

38. The device of claim 36 wherein the genomic data are in at least one of the following formats: BAM, SAM, VCF, and MAF.

39. The device of claim 36 wherein the omic analysis rules set includes medication guidance rules.

40. The device of claim 36 wherein the omic analysis rules set includes a simulation rules set.

41. A mobile device comprising:
a secured computer readable memory configured to operate as an omic data store that stores omic objects representative of at least a portion of an omic data set; and
an omic analysis engine coupled with the secured computer readable memory and configured to:
obtain at least one omic object according to a secure protocol;
generate a recommendation by applying an omic analysis rule set to the at least one omic object; and
initiate an action via an interface according to the recommendation.

42. The device of claim 41, wherein the omic objects comprise at least one of the following types of omic data: genomics, proteomics, lipidomics, transcriptomics, epigenomics, and kinomics.

43. The device of claim 41, further comprising a network interface.

44. The device of claim 43, wherein the network interface is configured to couple with at least one of the following types of networks: an intranet, the Internet, a private network, a LAN, a WAN, a VPN, an internal computing bus, a distributed network, a P2P network, a mesh network, an ad-hoc network, a personal area network, a wired network, and a wireless network.

45. The device of claim 41, wherein the omic objects are encrypted.

46. The device of claim 41, wherein the computer readable memory adheres to a secure memory standard.

47. The device of claim 41, wherein the omic objects are stored according to at least one of the following formats: BAM, SAM, VCF, and MAF.

48. The device of claim 41, wherein the omic objects are stored according to a lossy format.

49. The device of claim 41, wherein the omic objects represent a fractal representation of the omic data set.

50. The device of claim 41, wherein the omic analysis rules set includes medication guidance rules.

51. The device of claim 41, wherein the omic analysis rules set includes sample provenance testing rules.

52. The device of claim 41, wherein the omic analysis rules set includes disease testing rules.

53. The device of claim 41, wherein the omic analysis rules set includes at least one of the following rules: real-time analysis rules, treatment rules, prognosis rules, vaccine development rules, sequence detection rules, sequence tracking rules, infection tracking rules, circulating tumor cell detection rules, and notification rules.

54. The device of claim 41, wherein the omic analysis rules set includes a simulation rules set.

55. The device of claim 41, wherein the omic analysis engine comprises a mobile omic data browser

56. The device of claim 55, wherein the mobile omic data browser comprises a tumor browser.

57. The device of claim 41, further comprising an omic data interface.

58. The device of claim 57, wherein the omic data interface comprises at least one interface configured to capture one of the following types of sequence data as at least one omic object: a nanopore sequencing interface, a photon sequencing interface, and an electron sequencing interface.

59. The device of claim 41, wherein the action comprises displaying a report.

60. The device of claim 41, wherein the action comprises generating an alert.

61. The device of claim 41, wherein the action comprises sending a notification.

62. The device of claim 41, wherein the action comprises initiating a transaction.

63. The device of claim 41, wherein the action comprises submitting data to an electronic medical record.
